(19) United States
(12) Patent Application Publication
(10) Pub. No.: US 2012/0086194 A1
(43) Pub. Date: Apr. 12, 2012

(54) SADDLE FRAME FOR PNEUMATIC BULK TRAILER

(75) Inventor: Tom Carrier, Brookville, PA (US)

(73) Assignee: TRAIL KING INDUSTRIES, INC., Mitchell, SD (US)

(21) Appl. No.: 12/899,871

(22) Filed: Oct. 7, 2010

(51) Int. Cl. B60P 3/22; B21D 53/88

(52) U.S. Cl. 280/837; 29/897.2

(57) ABSTRACT

A saddle frame for a pneumatic bulk trailer includes first and second longitudinal saddle plates and at least one transverse support plate. Each of the saddle plates includes a front end, a rear end, an inner side, a generally arcuate upper edge, and a lower edge having at least three portions. Inwardly-directed edge flanges are formed at each portion of the lower edges. The transverse support plate extends between the inner sides of the saddle plates and is supported on an edge flange of each saddle plate. The upper edges of the saddle plates define support surfaces for engaging a pneumatic vessel of the pneumatic bulk trailer. The saddle plates are configured to be coupled to a front chassis frame and a rear chassis frame of the pneumatic bulk trailer.

### TECHNICAL FIELD

This invention relates to a pneumatic bulk trailer for transporting dry or liquid goods in a pneumatic vessel, and more particularly, to a support frame for the pneumatic vessel of a pneumatic bulk trailer.

### BACKGROUND

Pneumatic bulk trailers are widely used to transport bulk cargo such as dry food products (e.g., grain) and ore. A typical pneumatic bulk trailer includes a pneumatic vessel that has a discharge port at the bottom for discharging the bulk cargo at a destination. The pneumatic vessel is sealed such that pneumatic pressure can be applied in the vessel to force all of the bulk cargo through the discharge port. The conventional design for the pneumatic vessel also includes a contoured or arcuate bottom wall such that the bulk cargo naturally tends to fall with gravity toward the discharge port. For an elongate pneumatic vessel configured for over-the-road transport, the bottom wall will have a smooth arcuate contour both in longitudinal cross-section and transverse cross-section. Pneumatic bulk trailers are therefore specially designed to securely and reliably support the contoured arcuate bottom wall of the pneumatic vessel.

Conventional pneumatic bulk trailers have been formed by coupling a front chassis frame and a rear chassis frame to the pneumatic vessel with a plurality of shaped gussets and plates configured to engage a portion of the bottom wall of the pneumatic vessel. These gussets and plates are not integral with the pneumatic vessel or either of the front and rear chassis frames. Furthermore, each gusset or plate must be individually fitted to the pneumatic vessel, which is a time consuming and costly process. Forming the support framework for the pneumatic vessel from many different components also increases the number of potential failure points when the pneumatic bulk trailer is under load. Additionally, the plurality of gussets and plates adds to the weight of the pneumatic bulk trailer, which limits the total weight of bulk cargo that may be carried by the pneumatic vessel.

Consequently, it would be desirable to provide a support frame for a pneumatic bulk trailer that addresses these and other problems of conventional pneumatic bulk trailers.

### SUMMARY

A saddle frame for a pneumatic bulk trailer according to one embodiment of the present invention includes first and second longitudinal saddle plates. Each of the saddle plates includes a front end, a rear end, and an inner side facing toward the other saddle plate. Each saddle plate also includes a generally arcuate upper edge defining a longitudinal support surface configured to engage a pneumatic vessel between the front end and the rear end. Each saddle plate further includes a lower edge having at least three portions with corresponding first, second, and third edge flanges extending inwardly at the inner side. The saddle frame also includes at least one transverse support plate extending between the inner sides of the first and second saddle plates. The transverse support plate is supported by at least one of the edge flanges on each of the first and second saddle plates.

The transverse support plate may also include a generally arcuate upper edge defining a transverse support surface configured to engage the pneumatic vessel between the first and second saddle plates. The saddle frame may include a first transverse support plate disposed adjacent to the first and second edge flanges of each saddle plate, and a second transverse support plate disposed adjacent to the second and third edge flanges of each saddle plate. The saddle frame may also include a front end reinforcement plate coupled to the front end of the first saddle plate and the front end of the second saddle plate. A rear end reinforcement plate may be coupled to the rear end of the first saddle plate and the rear end of the second saddle plate.

In another embodiment, a pneumatic bulk trailer includes a pneumatic vessel, a front chassis frame, a rear chassis frame, and a saddle frame. The pneumatic vessel includes a top wall, a front wall, a back wall, and a bottom wall. The bottom wall defines a generally arcuate contour in the longitudinal direction between the front and back walls and also defines a generally arcuate contour in the transverse direction below the top wall. The saddle frame again includes first and second longitudinal saddle plates having arcuate upper edges and edge flanges along lower edges. The bottom wall of the pneumatic vessel is supported by the upper edges of the saddle plates as well as an upper edge of a transverse support plate extending between the first and second saddle plates. The front chassis frame and rear chassis frame are coupled to the saddle frame to form a unitary support structure for the pneumatic vessel.

In yet another embodiment, a method for manufacturing a saddle frame for supporting a pneumatic vessel includes cutting a flat sheet of material to form first and second saddle plate blanks. The saddle plate blanks include a front end, a rear end, a generally arcuate upper edge, and a lower edge having at least three portions. The method also includes bending the lower edge of each of the saddle plate blanks into edge flanges, thereby forming the first and second saddle plates. A transverse support plate is coupled to each of the first and second saddle plates such that the transverse support plate is supported on at least one of the edge flanges of each of the saddle plates.

### BRIEF DESCRIPTION OF THE DRAWINGS

The accompanying drawings, which are incorporated in and constitute a part of this specification, illustrate an embodiment of the invention and, together with a general description of the invention given below, serve to explain the principles of the invention.

FIG. 1 is a perspective view of one embodiment of a pneumatic bulk trailer including a saddle frame according to the invention.

FIG. 2 is a perspective view of a central portion of the saddle frame of FIG. 1.

### DETAILED DESCRIPTION

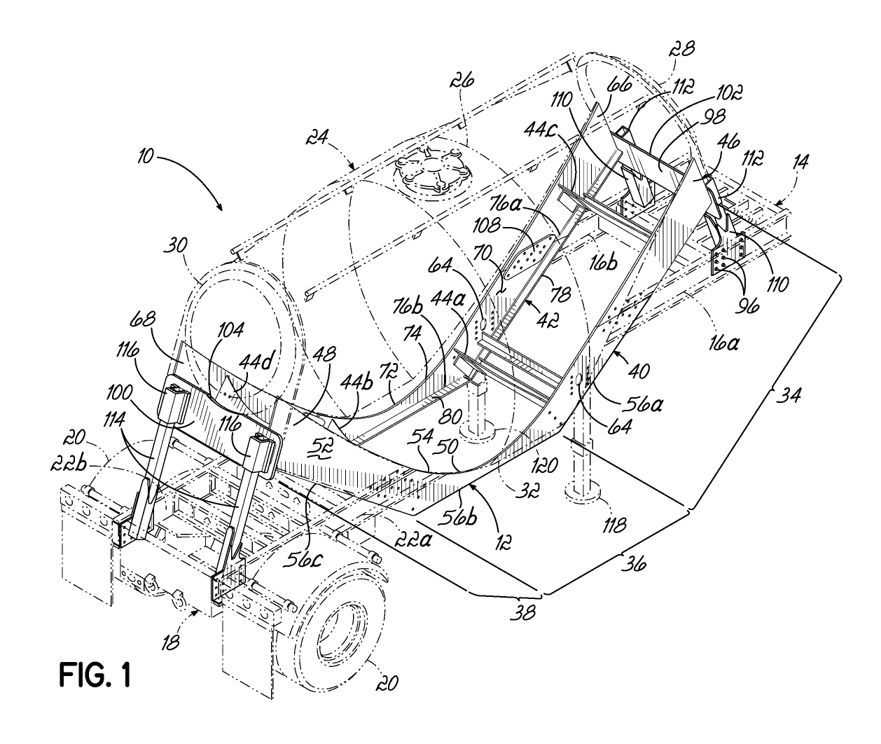

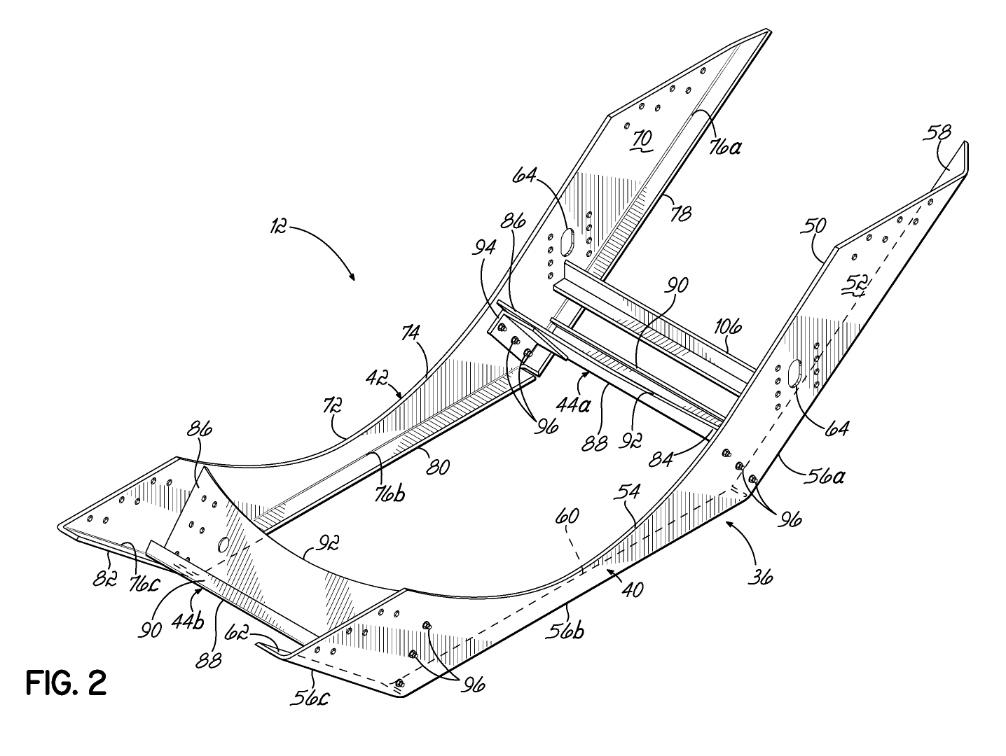

FIGS. 1 and 2 illustrate an exemplary embodiment of a pneumatic bulk trailer 10 having a saddle frame 12. Certain components of the pneumatic bulk trailer 10 are shown in phantom in FIG. 1 such that all features of the saddle frame 12 are visible. The pneumatic bulk trailer 10 includes a front chassis frame 14 configured to couple the trailer 10 to a towing vehicle such as a tractor trailer (not shown). The front chassis frame 14 includes first and second structural beams 16a, 16b disposed along a longitudinal direction of the trailer 10. The trailer 10 also includes a rear chassis frame 18 having at least two wheels 20. The rear chassis frame 18 also includes first and second structural beams 22a, 22b disposed along a longitudinal direction of the trailer 10. The saddle frame 12 is coupled to each of the front chassis frame 14 and the rear chassis frame 18 to provide a unitary framework for holding a pneumatic vessel 24.

The pneumatic vessel 24 is a closed structure defined by a top wall 26, a front wall 28, a rear wall 30, and a bottom wall 32. The bottom wall 32 is contoured such that the entire bottom wall 32 slopes downwardly toward a discharge port (not shown) at the very bottom of the pneumatic vessel 24. In this regard, the bottom wall 32 defines an arcuate contour in the longitudinal direction of the trailer 10 and an arcuate contour in the transverse direction of the trailer 10. The longitudinal arcuate contour of the bottom wall 32 defines an elongate generally V-shaped lower end of the pneumatic vessel 24 between the front wall 28 and the rear wall 30. The transverse arcuate contour of the bottom wall 32 abuts the top wall 26 on both sides of the pneumatic vessel 24. The saddle frame 12 is shaped to engage the bottom wall 32 of the pneumatic vessel 24. It will be understood that the below-described embodiment of the saddle frame 12 could be modified to accommodate any pneumatic vessel with differing bottom wall contours.

The saddle frame 12 of the exemplary embodiment includes a front portion 34, a central portion 36, and a rear portion 38 as shown in FIG. 1. The saddle frame includes a first longitudinal saddle plate 40, a second longitudinal side plate 42, and a plurality of transverse support plates 44 extending between the first saddle plate 40 and second saddle plate 42. The first and second saddle plates 40, 42 and the plurality of transverse support plates 44 are configured to directly engage the bottom wall 32 of the pneumatic vessel 24. Although the saddle frame 12 in the exemplary embodiment is made from multiple connected plates, it will be appreciated that the saddle frame 12 could alternatively be formed from a unitary sheet of material in other embodiments.

The first saddle plate 40 includes a front end 46, a rear end 48, an inner side 50 facing toward the second saddle plate 42, and an outer side 52 facing away from the second saddle plate 42. The first saddle plate 40 includes a generally arcuate upper edge 54 extending from the front end 46 to the rear end 48. The upper edge 54 defines a longitudinal support surface sized and shaped to engage the longitudinal arcuate contour of the bottom wall 32 of the pneumatic vessel 24. The first saddle plate 40 also includes a lower edge 56 having three generally linear portions 56a, 56b, 56c extending in series from the front end 46 to the rear end 48. The first saddle plate 40 further includes a first edge flange 58 extending inwardly from the first portion 56a of the lower edge 56, a second edge flange 60 extending inwardly from the second portion 56b of the lower edge 56, and a third edge flange 62 extending inwardly from the third portion 56c of the lower edge 56. The edge flanges 58, 60, 62 are formed integrally with the first longitudinal saddle plate 40 (such as part of a first saddle plate blank cut from a flat sheet of material) and bent inwardly to be approximately perpendicular to the inner side 50. The first saddle plate 40 may also include at least one auxiliary aperture 64 between the upper edge 54 and the lower edge 56, for reasons explained in further detail below.

In a similar manner as the first saddle plate 40, the second saddle plate 42 includes a front end 66, a rear end 68, an inner side 70 facing toward the first saddle plate 40, and an outer side 72 facing away from the first saddle plate 40. The second saddle plate 42 includes a generally arcuate upper edge 74 extending from the front end 66 to the rear end 68. The upper edge 74 defines a longitudinal support surface sized and shaped to engage the longitudinal arcuate contour of the bottom wall 32 of the pneumatic vessel 24. The second saddle plate 42 also includes a lower edge 76 having three generally linear portions 76a, 76b, 76c extending in series from the front end 66 to the rear end 68. The second saddle plate 42 further includes a first edge flange 78 extending inwardly from the first portion 76a of the lower edge 76, a second edge flange 80 extending inwardly from the second portion 76b of the lower edge 76, and a third edge flange 82 extending inwardly from the third portion 76c of the lower edge 76. The edge flanges 78, 80, 82 are formed integrally with the second longitudinal saddle plate 42 (such as part of a second saddle plate blank cut from a flat sheet of material) and bent inwardly to be approximately perpendicular to the inner side 70. The second saddle plate 42 may also include at least one auxiliary aperture 64 between the upper edge 74 and the lower edge 76, for reasons explained in further detail below.

The plurality of transverse support plates 44 includes a first transverse support plate 44a extending between the inner sides 50, 70 of the saddle plates 40, 42 adjacent to each of the first edge flanges 58, 78 and each of the second edge flanges 60, 80. More specifically, the first transverse support plate 44a includes a first edge 84 adjacent to the inner side 50 of the first saddle plate 40 and a second edge 86 adjacent to the inner side 70 of the second saddle plate 42. The first transverse support plate 44a also includes a lower edge 88 having a transverse edge flange 90 sitting on the first edge flanges 58, 78, and an arcuate upper edge 92. The arcuate upper edge 92 defines a transverse support surface for engaging the transverse arcuate contour of the bottom wall 32 of the pneumatic vessel 24. The first and second edges 84, 86 of the first transverse support plate 44a are coupled to the respective inner sides 50, 70 with L-brackets 94 and bolts 96 as well understood in the art. It will be understood that the first transverse support plate 44a could be coupled to the first and second saddle plates 40, 42 with other known method of structural bonding such as spot welding without departing from the scope of this invention.

The plurality of transverse support plates 44 also includes a second transverse support plate 44b extending between the inner sides 50, 70 of the saddle plates 40, 42 adjacent to each of the second edge flanges 60, 80 and each of the third edge flanges 62, 82. The second transverse support plate 44b includes each of the same elements previously described with respect to the first transverse support plate 44a, including the first edge 84, the second edge 86, the lower edge 88, the transverse edge flange 90, and the arcuate upper edge 92. The only difference is the location of the second transverse support plate 44b, which is supported by the third edge flanges 62, 82 of the first and second saddle plates 40, 42. The plurality of transverse support plates may include additional transverse support plates 44c, 44d as shown in FIG. 1 in additional locations along the first and second saddle plates 40, 42.

The saddle frame 12 further includes a front end reinforcement plate 98 and a rear end reinforcement plate 100. The front end reinforcement plate 98 is coupled to the front end 46 of the first saddle plate 40 and the front end 66 of the second saddle plate 42. The front end reinforcement plate 98 also includes an upper edge 102 configured to abut or be adjacent to the front wall 28 of the pneumatic vessel 24. In a similar manner, the rear end reinforcement plate 100 is coupled to the rear end 48 of the first saddle plate 40 and the rear end 68 of the second saddle plate 42. The rear end reinforcement plate 100 also includes an upper edge 104 configured to abut or be adjacent to the rear wall 30 of the pneumatic vessel 24. The first and second saddle plates 40, 42, the plurality of transverse support plates 44, and the front and rear reinforcement plates 98, 100 collectively define a support-web like structure for securely and reliably holding the pneumatic vessel 24 on the pneumatic bulk trailer 10. The saddle frame 12 may include additional transverse beams 106 coupled to the saddle plates 40, 42 for additional stress resistance, as is well understood in the art.

The front chassis frame 14 is coupled to the saddle frame 12 in a plurality of locations. First, the free ends of the first and second structural beams 16a, 16b are disposed along the outer sides 52, 72 of the respective first and second saddle plates 40, 42 and coupled to the saddle plates 40, 42 with a plurality of bolts 96 and jack plates 108 positioned on the respective inner sides 50, 70. In embodiments like the exemplary embodiment of the saddle frame 12, the front portion 34 and central portion 36 of the saddle frame 12 can also be joined together at these junctions with the first and second structural beams 16a, 16b. Additionally, the trailer 10 may include a pair of front struts 110 coupling the front end reinforcement plate 98 and the first and second structural beams 16a, 16b. As shown in FIG. 1, the front struts 110 may be engaged with corresponding receptacles 112 on the front end reinforcement plate 98 and rigidly held on the first and second structural beams 16a, 16b with a plurality of bolts 96. One will understand that alternative methods of coupling the front struts 110 are possible within the scope of this invention.

In a similar manner, the rear chassis frame 18 is coupled to the saddle frame 12 in a plurality of locations. First, the free ends of the first and second structural beams 22a, 22b are disposed along the outer sides 52, 72 of the respective first and second saddle plates 40, 42 and coupled to the saddle plates 40, 42 with a plurality of bolts 96 and jack plates 108 positioned on the respective inner sides 50, 70. In embodiments like the exemplary embodiment of the saddle frame 12, the rear portion 38 and central portion 36 of the saddle frame 12 can also be joined together at these junctions with the first and second structural beams 22a, 22b. Additionally, the trailer 10 may include a pair of rear struts 114 coupling the rear end reinforcement plate 100 and the first and second structural beams 22a, 22b. As shown in FIG. 1, the rear struts 114 may be engaged with corresponding receptacles 116 on the rear end reinforcement plate 100 and rigidly held on the first and second structural beams 22a, 22b with a plurality of bolts 96. One will understand that alternative methods of coupling the rear struts 114 are possible within the scope of this invention.

Each of the elements of the trailer 10 may be formed from structural materials such as steel, aluminum, and other materials known in the art. The auxiliary apertures 64 of the first and second saddle plates are used to mount additional equipment or optional equipment for the trailer. In the exemplary embodiment shown, a first trailer support jack 118 is coupled to the auxiliary aperture 64 along the first saddle plate 40, while a second trailer support jack 120 is coupled to the auxiliary aperture 64 along the second saddle plate 42. As is well understood in the art, the first and second trailer support jacks 118, 120 along with the wheels 20 support the trailer 10 when not coupled to a towing vehicle. In summary, the saddle frame 12 is coupled to the front chassis frame 14 and the rear chassis frame 18 to form a unitary structure with the pneumatic vessel 24. The saddle frame 12 provides a superior resistance to load stress encountered during over-the-road transport of bulk cargo with the pneumatic bulk trailer 10. Additionally, the saddle frame 12 may be easily manufactured and reconfigured for any pneumatic vessel 24 by cutting and bending flat sheet stock as previously described.

While the present invention has been illustrated by the description of the embodiment thereof, and while the embodiment has been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A saddle frame for a pneumatic bulk trailer having a pneumatic vessel, the saddle frame comprising:
first and second longitudinal saddle plates, each saddle plate including a front end, a rear end, an inner side facing toward the other saddle plate, a generally arcuate upper edge defining a longitudinal support surface configured to engage the pneumatic vessel between the front end and the rear end, and a lower edge having at least three portions with corresponding first, second, and third edge flanges extending inwardly at the inner side; and
at least one transverse support plate extending between the inner sides of the first and second saddle plates and supported by at least one of the edge flanges of each of the first and second saddle plates.

2. The saddle frame of claim 1, wherein the at least one transverse support plate further includes a generally arcuate upper edge defining a transverse support surface configured to engage the pneumatic vessel between the first and second saddle plates.

3. The saddle frame of claim 1, wherein the at least one transverse support plate includes a first transverse support plate disposed adjacent to the first and second edge flanges of each of the first and second saddle plates, and a second transverse support plate disposed adjacent to the second and third edge flanges of each of the first and second saddle plates.

4. The saddle frame of claim 1, further comprising:
a front end reinforcement plate coupled to the front end of the first saddle plate and the front end of the second saddle plate; and
a rear end reinforcement plate coupled to the rear end of the first saddle plate and the rear end of the second saddle plate.

5. The saddle frame of claim 1, wherein each of the first and second saddle plates further includes at least one auxiliary aperture between the upper edge and the lower edge, the at least one auxiliary aperture configured to couple to auxiliary equipment of the pneumatic bulk trailer.

6. A pneumatic bulk trailer comprising:
a pneumatic vessel having a top wall, a front wall, a back wall, and a bottom wall defining a generally arcuate contour in the longitudinal direction between the front and back walls and a generally arcuate contour in the transverse direction below the top wall;
a front chassis frame configured to couple to a towing vehicle;
a rear chassis frame including at least two wheels; and
a saddle frame coupled to the front chassis frame and the rear chassis frame, the saddle frame including:
first and second longitudinal saddle plates, each saddle plate including a front end, a rear end, an inner side facing toward the other saddle plate, a generally arcuate upper edge defining a longitudinal support surface configured to engage the pneumatic vessel between the front end and the rear end, and a lower edge having at least three portions with corresponding first, second, and third edge flanges extending inwardly at the inner side; and
at least one transverse support plate extending between the inner sides of the first and second saddle plates and supported by at least one of the edge flanges of each of the first and second saddle plates.

7. The pneumatic bulk trailer of claim 6, wherein each of the first and second saddle plates further include an outer side facing away from the other saddle plate, and wherein the front chassis frame and the rear chassis frame are coupled to the outer sides of the first and second saddle plates.

8. The pneumatic bulk trailer of claim 6, wherein the at least one transverse support plate further includes a generally arcuate upper edge defining a transverse support surface configured to engage the pneumatic vessel between the first and second saddle plates.

9. The pneumatic bulk trailer of claim 6, wherein the at least one transverse support plate includes a first transverse support plate disposed adjacent to the first and second edge flanges of each of the first and second saddle plates, and a second transverse support plate disposed adjacent to the second and third edge flanges of each of the first and second saddle plates.

10. The pneumatic bulk trailer of claim 6, wherein the saddle frame further includes:
a front end reinforcement plate coupled to the front end of the first saddle plate and the front end of the second saddle plate; and
a rear end reinforcement plate coupled to the rear end of the first saddle plate and the rear end of the second saddle plate.

11. The pneumatic bulk trailer of claim 10, further comprising:
front struts coupling the front chassis frame and the front end reinforcement plate; and
rear struts coupling the rear chassis frame and the rear end reinforcement plate.

12. The pneumatic bulk trailer of claim 6, wherein each of the first and second saddle plates further includes at least one auxiliary aperture between the upper edge and the lower edge, the at least one auxiliary aperture configured to couple to auxiliary equipment of the pneumatic bulk trailer.

13. The pneumatic bulk trailer of claim 12, further comprising:
a first trailer support jack coupled to the first saddle plate at the at least one auxiliary aperture; and
a second trailer support jack coupled to the second saddle plate at the at least one auxiliary aperture.

14. A method of manufacturing a saddle frame for supporting a pneumatic vessel of a pneumatic bulk trailer, the method comprising:
cutting a flat sheet of material to form first and second saddle plate blanks having a front end, a rear end, a generally arcuate upper edge between the front end and the rear end, and a lower edge having at least three portions;
bending the lower edge of each of the first and second saddle plate blanks into edge flanges to form first and second saddle plates;
coupling a transverse support plate to each of the first and second saddle plates such that the transverse support plate is supported on at least one of the edge flanges of each of the first and second saddle plates.

15. The method of claim 14, further comprising:
coupling a front end reinforcement plate to the front end of the first saddle plate and the front end of the second saddle plate; and
coupling a rear end reinforcement plate to the rear end of the first saddle plate and the rear end of the second saddle plate.

16. The method of claim 14, further comprising:
coupling the first saddle plate and the second saddle plate to a front chassis frame of the pneumatic bulk trailer; and
coupling the first saddle plate and the second saddle plate to a rear chassis frame of the pneumatic bulk trailer.
